(19) United States
(12) Patent Application Publication
(10) Pub. No.: US 2014/0200958 A1
(43) Pub. Date: Jul. 17, 2014

(54) SYSTEM AND METHOD FOR CATEGORIZATION OF FACTORS TO PREDICT DEMAND

(71) Applicant: Timo Wagenblatt, Bornheim (DE)

(72) Inventor: Timo Wagenblatt, Bornheim (DE)

(73) Assignee: SAP AG, Walldorf (DE)

(21) Appl. No.: 13/739,887

(22) Filed: Jan. 11, 2013

(51) Int. Cl. G06Q 30/02

(52) U.S. Cl. CPC G06Q 30/0202
USPC 705/7.31

(57) ABSTRACT

In an example embodiment, point of sale and other demand data is enriched with data that has a qualitative aspect, such as weather data or data from a social media network (e.g. trending topics, “buzz”, etc). Some embodiments take such data and quantify it to turn the qualitative aspect of the data into a quantitative aspect using a set of rules that may account variability among geographic region, customer perception, and/or various other criteria. The quantified data may then be classified according to a variety of data dimensions and may then be combined to enrich other available data. Predictive models may be created therefrom. Such predictive modeling may then be used to predict demand and/or consumer behavior and can influence marketing campaigns, etc.

### TECHNICAL FIELD

This disclosure relates to predicting demand for an entity like product or customer or customer/product combination. More specifically, this disclosure relates to predicting demand for an entity based on conditions that are difficult to predict and that are hard to use in prediction and optimization processes such as weather or social media buzz.

### BACKGROUND

For companies selling products through the consumer channels of distribution (e.g. retail stores, the Internet, or other Point of Sale (POS) locations), between 10% and 20% of their revenues is spent on promotions, pricing discounts, rebates and other monetary incentives. In a single year, this can amount to a substantial investment. Although wise use of this spending is of paramount importance and concern, it is also very difficult. Sales and marketing plans are sometimes created 3-18 months in advance and investments in secondary product placements, marketing campaigns, coupons, etc. can be largely wasted by unforeseen or unpredictable events, such as sudden inclement weather.

### BRIEF DESCRIPTION OF DRAWINGS

FIG. 1 is a diagram illustrating collection of point of sale information, in accordance with an example embodiment

FIG. 2 is a diagram illustrating a system to predict product demand, in accordance with an example embodiment.

FIG. 3 is a diagram illustrating an in-memory database management system, in accordance with an example embodiment.

FIG. 4 is a diagram illustrating an index server, in accordance with an example embodiment.

FIG. 5 is a diagram illustrating a representative process stack, in accordance with an example embodiment.

FIG. 6 is a diagram illustrating a system to predict product demand, in accordance with an example embodiment.

FIG. 7 is a block diagram of a computer processing system, within which a set of instructions for causing the computer to perform any one or more of the methodologies discussed herein may be executed.

### DETAILED DESCRIPTION

The description that follows includes illustrative systems, methods, techniques, instruction sequences, and computing machine program products of illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general well-known instruction instances, protocols, structures, and techniques have not been shown in detail.

The disclosure herein is broad enough to apply to an entity such as a product, a customer or a product/customer combination. Thus, although the general description is often described in terms of a product, the embodiments herein may apply to any like entity (e.g., customer, product/customer combination).

In an example embodiment, point of sale and other product demand data is enriched with data that is difficult or impossible to predict reliably, such as weather data or data from a social media network (e.g. trending topics, “buzz”, etc.). Sales and marketing plans are often created a long time in advance (3-18 months in many instances), so using data that is difficult or impossible to predict (such as weather or social media data) in such marketing plans can be extremely challenging if not impossible. Often such data has a qualitative aspect. In the context of this disclosure, a qualitative aspect means data (or aspects of data) that impact demand wholly or in part through perceptions of a purchaser of the product. Such perceptions often vary by geographic location, time of year, or other factors. For example, in one geographic location 80 degrees Fahrenheit may be perceived as pleasant or “good” while in another geographic location 80 degrees Fahrenheit may be perceived as hot or “bad”. Such perceptions may change if the temperature occurs in the middle of the summer or in winter. In another example, trending topics on a social media site may influence perceptions of a product, a company, a promotional campaign, etc. Perceived value of a product is yet another example and can vary in accordance with a variety of parameters.

Some embodiments disclosed herein take such data and quantify it to turn the qualitative aspect of the data into a quantitative aspect that can be manipulated and utilized in a variety of ways. This may be accomplished by rules that may account variability among geographic region, customer perception, and/or various other criteria. The quantified data may then be classified according to a variety of data dimensions and may then be combined to enrich other available data. Predictive models may be created therefrom. Such predictive modeling may then be used to predict demand and/or consumer behavior and can influence marketing campaigns, etc.

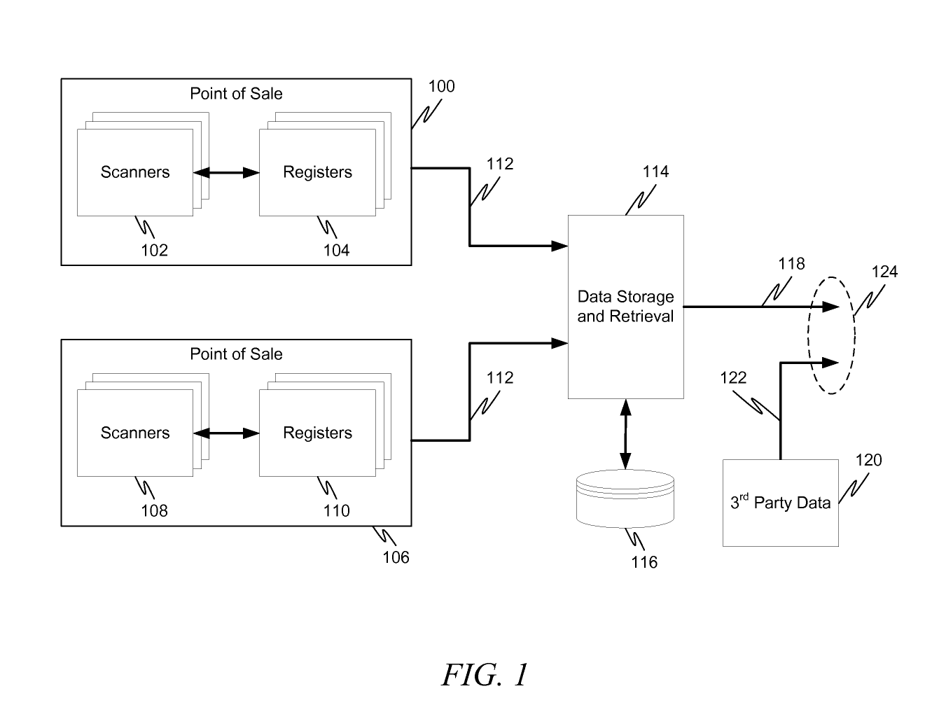

FIG. 1 is a diagram illustrating collection of point of sale information, in accordance with an example embodiment. In FIG. 1, two point of sale (POS) locations are shown as 100 and 106. At the POS 100 electronic scanners 102, registers 104, and other electronic scanning and data gathering devices (not shown) record transactions and other information such as customer loyalty information. The collected data may be electronically transferred to one or more locations where the data can be stored and possibly processed further. In FIG. 1, such a transfer is illustrated by 112 and a representative location is illustrated by data storage and retrieval location 114,. POS data 112 is typically transferred over a wired or wireless (or both) network. At location 114, received data is typically placed in a data store, such as a database or other store, represented in FIG. 1 by data store 116.

In FIG. 1, POS 106 is identical to POS 100 with scanners 108, register 110, and other electronic scanning and data gathering devices (not shown). However, this is not required. POS 106 may be different from POS 100 and contain more or fewer items such as scanners, registers, or other data gathering devices. POS 106 may transfer POS data 112 to a location, such as the data storage and retrieval facility 114. The data is typically transferred over a wired or wireless (or both) network. At location 114, received data is typically placed in a data store such as data store 116.

POS data may include a wide variety of information, such as the particular product sold, the Universal Product Code/International Article Number (UPC/EAN), the product category, product group, account, account Hierarchy, target group, and/or any other type of information. Furthermore, these can be gathered and sent by a POS location (such as POS 100 or 106) or they may be added later by another system or at another location. For example, the UPC of the product may be recorded by the scanner, the account added by other systems at the POS location, and the product category, product group, etc. added after the data has been transferred. Customer and loyalty information may also be collected and/or added, in accordance with appropriate privacy policies and laws. By way of example, such data can include customer demographic data (age, gender, residence, etc.) as well as purchase history, etc.

Most of the above information (e.g. product, UPC/EAN, product category, etc.) listed above is self-explanatory. However, for clarity the following further example explanations are given. The product category may be a general category of the product such as shampoo or dairy products. A product group combines other product groups, product categories, products and/or materials according to whatever criteria best meets the needs of an enterprise. Examples may include things like foodstuffs or hardware. An account may be an entity within a business or organizational structure. For example, it can be an individual store or location, a particular distribution channel, a chain of outlets, or whatever suits the needs of an enterprise. An account hierarchy allows an entity to map complex organizational structures of a business or business partner (e.g. a hierarchy of accounts). An account hierarchy is typically created for statistical purposes, marketing analyses, or other such purposes. Target groups can be created with reference to specific marketing activities, for example, an email marketing campaign intended to introduce a new product or a campaign targeted to loyal customers. In addition, with information collected as part of loyalty programs, information about particular groups or purchasers may be included, in accordance with appropriate privacy policies and laws.

For analytical and other purposes the data stored in data store 116 may retrieved 118. Such data 118 may also be supplemented by other data 122 from, for example, third party data source 120. Note that this is simply representative of further data sources and such data may or not actually come from third parties. Retrieval of data 118 and supplemental data 122 is illustrated by 122. Retrieval of the data 122 may be for immediate viewing and/or for other purposes such as preparation of a marketing and/or other plan.

Supplemental data 122 may be any type of data. In one embodiment, supplemental data 122 relates to a qualitative parameter that impacts demand tor a product as the data varies over a range. Data that relates to such a qualitative parameter has a qualitative aspect. Qualitative aspects may exist, for example, because the parameter impacts demand wholly or in part through perceptions of a purchaser of the product. Such perceptions often vary by geographic location, time of year, or other factors. As previously discussed, examples of such data include weather data, information from social media networks, perceived product value, etc. Weather data can include such parameters as temperature, precipitation, humidity and other meteorological factors. Weather data may also be associated with a geographic location or region.

Although weather data may be very quantitative on the one hand (e.g. temperature, precipitation, etc. are all represented by quantitative numbers), its effect on, for example, product demand is not. When the temperature rises, demand for a product such as ice cream may increase. The particular temperature where demand starts to increase, and the slope and shape of any such demand curve may vary widely m different geographic regions. For example, in a typically cold location, such as Alaska, demand may begin to increase at a lower temperature than a typically hot location, such as Arizona. Additionally, the time of year may also influence such demand and the temperature at which demand increases. In this sense, weather is very qualitative. A similar example exists in data from social media networks, where trending topics and/or “buzz” may increase demand based on a variety of factors. Perceived product value is another type of qualitative data that may be used in a similar fashion.

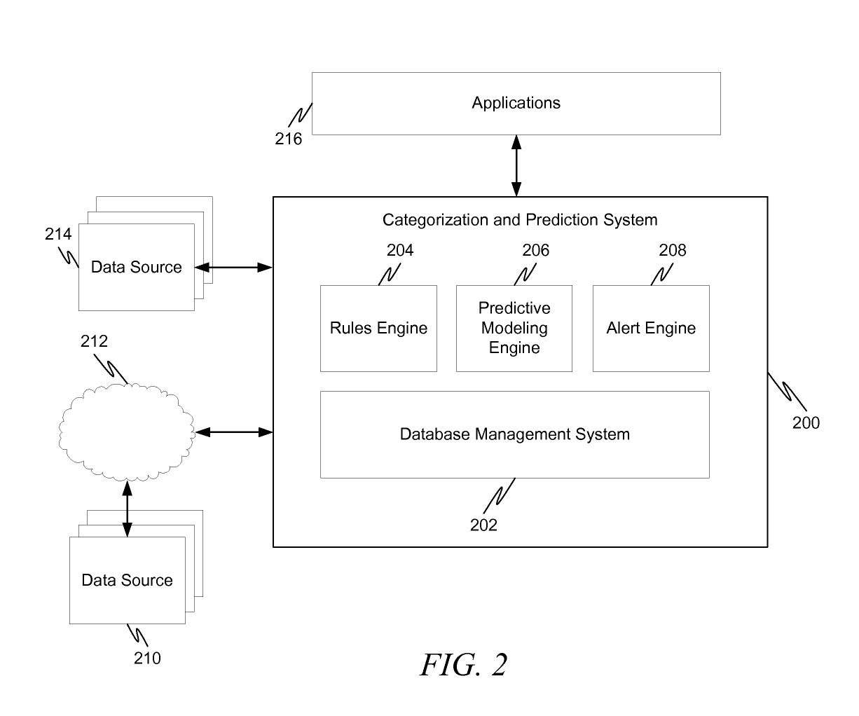

FIG. 2 is a diagram illustrating a system, shown as 200, to predict product demand, in accordance with an example embodiment. System 200 may comprise a database management system 202, a rules engine 204, a predictive modeling engine 206, and an alert engine 208. Of course not all of the items may exist in all embodiments. System 200 receives information from one or more data sources, such as data sources 210 and/or data sources 214. These data sources may be directly connected, as in the case of 214 or connected through some sort of network 212 as in the case of 210. System 200 may form an application platform upon which other applications may be built. Additionally, or alternatively, system 200 may interact with other applications, which can take information from system 200 and further process it or utilize it in a variety of ways. All these options are illustrated by applications 216.

Database management system 202 may store and retrieve data to accomplish the desired tasks. Such data may be retrieved from a variety of data sources (210, 214), which may be data feeds or data that has been previously collected and stored in a particular repository or repositories. Similarly, database management system may store and retrieve data in conjunction with other aspects such as rules engine 204, predictive modeling engine 206 and alert engine 208. In addition to storing and retrieving data, the database management system may implement other functionality and/or applications to accomplish or help accomplish the functions herein described. In other words, some or all of rules engine 204, predictive modeling engine 206 and/or alert engine 208 may be implemented in conjunction with, or in the context of, database management system 202.

Rules engine 204 may be adapted to perform a variety of tasks, such as quantify qualitative data (or data having a qualitative aspect) according to a set of rules. This set of rules may, for example, indicate various levels of desirability such as a spectrum where one end represents “bad” and the other end represents “good”. The rules may vary by geographic location so that data from one geographic location is quantified differently than data from another geographic location. As an example only, rules engine 204 may assign levels of desirability (e.g. “good” or “bad”) to weather data (temperature, precipitation, etc.) for a particular geographic region and different levels of desirability to weather data from a different geographic region. As an even more particular example, if a 1-10 scale exists where 1 is the most “bad” and 10 is the most “good”, spring weather data for a particular place in Minnesota may be rated as 6 when the weather approaches 45 degrees Fahrenheit, and may be rated as a 3 for a particular place in Florida for the same temperature. While only a single parameter has been discussed, multiple parameters can also be used (e.g. temperature and precipitation, or temperature, precipitation and humidity, etc.). The quantification process can also include a confidence level parameter that measures the confidence associated with the quantification level of a data point. Confidence levels can also be associated with the entire data set and not just a data point. Confidence levels can also be assigned to express the likelihood that a particular parameter will exist in the data set, such as a temperature at a particular time in a particular geographic region.

Rules engine 204 may also categorize data according to a variety of parameters. Categorization includes identifying a dimension, or particular set of dimensions, that are of interest. For example, sales or demand data may include such information as the particular product sold, the Universal Product Code/International Article Number (UPC/EAN), the product category, product group, account, account hierarchy, target group, some other sort of geographic location, POS description, and/or any other type of information. Other data including market research data or shipment data may include additional or alternative information. Any of these can be a dimension along which the data can be categorized. Categorized data can be combined with the quantified data (e.g. weather, social media, sentiment etc.) to yield an enriched data set.

Clustering may be performed on the enriched data set. In one aspect, clustering may determine which combination of parameters (attributes) occur most frequently together and may group the data by those attributes. For example, an enriched data set may include customer parameters such as gender, age, income, geographic location or region, occupation, products purchased, temperature and precipitation for the geographic location. Clustering may determine which attributes occur most frequently in combination such as male customers between ages 30 and 40 purchase orange juice when the temperature is between 85 and 95 degrees Fahrenheit. Clustering may be developed on one data set and used to predict what will happen in another data set. Clustering may be a function of the rules engine 204 or of database management system 202, or both, depending on the implementation of the embodiment. In another aspect, clustering may be performed around any parameter (or attribute) in the data set by selecting the desired parameters around which data should be clustered.

The enriched data set may form the basis for a predictive model that can be used to predict demand (or other factors) based on current or projected conditions. This is illustrated in FIG. 1 by predictive modeling engine 206. Predictive modeling can be accomplished in a variety of ways and many tools exist that will take a data set and create a predictive model from the data. Such predictive models will determine the relationship and sensitivity to change among various parameters in the data set. In one example, such a predictive model can be created using a regression analysis on various parameter dimensions. Such a regression analysis can include a least squares multiple regression analysis on the enriched data set in order to quantify the relationship between various parameters in the enriched data set. Such least squares multiple regression analysis is well known in the art. Other predictive modeling methodologies may also be used.

Predictive modeling can include Demand Science. Demand Science is the process of applying the scientific method in order to measure and predict demand. At a high level, demand science involves the following steps:
Acquisition of sufficient, accurate demand data and categorization of demand in influencing factors
Cleansing of demand data to remove spurious or erroneous data points
Enriching hard numeric facts with demand driver categorization results
Generation of demand models based on demand data
Demand forecasting using the demand models plus known/planned influencing factors
Evaluation of modeling quality and forecasting accuracy as desired

In a nutshell, demand science transforms historical demand data into demand models for demand forecasting or optimization.

Accurate and sufficient demand data should be obtained in order to ensure the best demand modeling and forecasting results. “Accurate” means minimal inherent errors (e.g. incorrect dates, accidental double aggregation). “Sufficient” means enough to obtain adequate results.

Prior to demand modeling, demand data may be programmatically cleansed to remove spurious or problematic data points called outliers. Removing outliers results in generally more robust and accurate demand models. Detection of out-of-stock time periods (product likely not available to shoppers) as well as product discontinuation (product likely not carried in store) can also be done leading to improved model accuracy.

An important part of demand science is the analysis of the model quality and forecast accuracy to determine the quality and health of the source demand data, models, and forecasts. Model quality can be assessed using model metrics or model time series analysis to validate the quality of the input demand data, configuration settings, and resulting model fits. Any data or configuration issues may be identified and fixed early leading to more accurate models and forecasts. Forecast accuracy can be assessed using hold-out analysis as well as forecast vs. actual comparisons.

Alert engine 208 may perform a variety of alert tasks. In one embodiment, alert engine 208 may be set to send an alert whenever a particular predicted parameter exceeds a defined threshold. This may mean that an alert is sent, for example, if the predicted demand exceeds a set threshold (there is no lower threshold) or falls below a set threshold (there is no upper threshold), or both (there is both a lower threshold and an upper threshold and an alert is sent whenever either is crossed). Similarly, alerts can be set to occur when some type of event may occur with a particular confidence level. For example, an alert may be sent when the weather forecast contains a particular type of event with a particular probability. As a particular example, if a marketing plan has been established with secondary product placement in the parking lot (such as a ‘tent sale’ or something similar), and if the forecast is for cold, wet weather, the system can factor that into product demand through the predictive model and alert if the impact of the forecasted weather exceeds certain criteria (perhaps with a certain confidence level). Alerts can take a variety of forms such as email, text messages, a phone call, a visual indicator on a screen, or any type of alert.

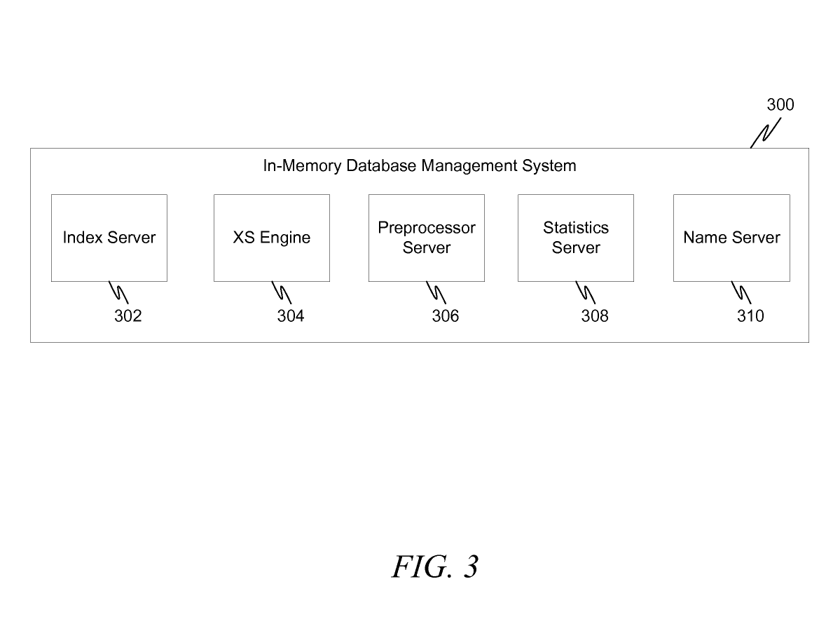

In some embodiments the system may be made using an in-memory database management system. FIG. 3 is a diagram illustrating an example in-memory database management system, in accordance with an example embodiment. An in-memory database is a database management system that primarily relies on main memory for computer data storage. It is contrasted with database management systems that employ a disk storage mechanism. One example of an in-memory database is the HANA system from SAP AG of Walldorf, Germany.

Here, an in-memory database system 380 includes an index server 302, an eXternal Subroutine (XS) Engine 304, a preprocessor server 306, a statistics server 308, and a name server 310. These components may operate on a single computing device, or may be spread among multiple computing devices (e.g., separate servers).

In an example embodiment, the index server 302 contains the actual data and the engines for processing the data. It also coordinates and uses all the other servers. In an example embodiment, a (or more than one) specialized database may maintained in the index server 302 to store information relevant to quantifying qualitative data, categorization of data, clustering, etc. The name server 310 holds information about the database topology. This is used in a distributed system with instances of the database on different hosts. The name server 310 knows where the components are running and which data is located on which server.

The statistics server 308 collects information about status, performance, and resource consumption foam all the other server components. The preprocessor server 306 is used for analyzing text data and extracting the information on which the text search capabilities are based. The XS engine 304 allows clients to connect to the database system 300 using Hypertext Transfer Protocol (HTTP).

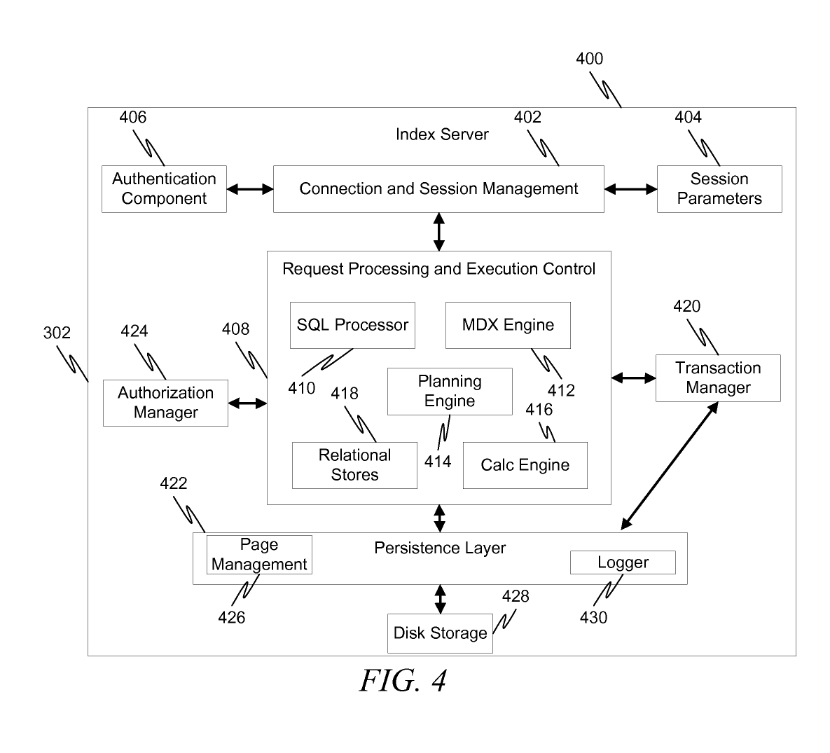

FIG. 4 is a diagram illustrating an index server, in accordance with an example embodiment. The index server may, in some embodiments, be utilized as the index server 302 in the system of FIG. 3. The index server 400 includes a connection and session management component 402, which is responsible for creating and managing sessions and connections tor the database clients. Once a session is established, clients can communicate with the database system (e.g., database system 300 of FIG, 3) using. SQL statements. For each session, a set of session parameters 404 may be maintained, such as auto-commit, current transaction isolation level. and the like. Users (and/or other database clients) are authenticated either by the database system itself (e.g., login with user name and password, using authentication component 406), or authentication can be delegated to an external authentication provider such as a Lightweight Directory Access Protocol (LDAP) directory.

The client requests can be analyzed and executed by a set of components summarized as request processing and execution control 408. The SQL processor 410 checks the syntax and semantics of the client SQL statements and generates a logical execution plan. Multidimensional expressions (MDX) is a language for querying and manipulating multidimensional data stored in Online Analytical Processing (OLAP) cubes. As such, an MDX engine 412 is provided to allow for the parsing and executing of MDX commands. A planning engine 414 allows financial planning applications to execute basic planning operations in the database layer. One such operation is to create a new version of a dataset as a copy of an existing dataset, while applying filters and transformations.

A calc engine 416 implements the various SQL scripts and planning operations. The calc engine 416 creates a logical execution plan for calculation models derived from SQL script, MDX, planning, and domain-specific models. This logical execution plan may include, for example, breaking up a model into operations that can be processed in parallel.

The data is stored in relational stores 418, which implement a relational database in main memory.

Each SQL statement may be processed in the context of a transaction. New sessions are implicitly assigned to a new transaction. The transaction manager 420 coordinates database transactions, controls transactional isolation, and keeps track of running and closed transactions. When a transaction is committed or rolled back, the transaction manager 420 informs the involved engines about this event so they can execute actions. The transaction manager 420 also cooperates with a persistence layer 422 to achieve atomic and durable transactions.

An authorization manager 424 is invoked by other database system components to check whether the user has the privileges to execute the requested operations. The database system allows for the granting of privileges to users or roles. A privilege grants the right to perform a specified operation on a specified object.

The persistence layer 422 ensures that the database is restored to the most recent committed state after a restart and that transactions are either completely executed or completely undone. To achieve this goal in an efficient way, the persistence layer 422 uses a combination of write-ahead logs, shadow paging, and save points. The persistence layer 422 also offers a page management interface 426 for writing and reading data to a separate disk storage 428, and also contains a logger 430 that manages the transaction log. Log entries can be written implicitly by the persistence layer 422 when data is written via the persistence interface or explicitly by using a log interface.

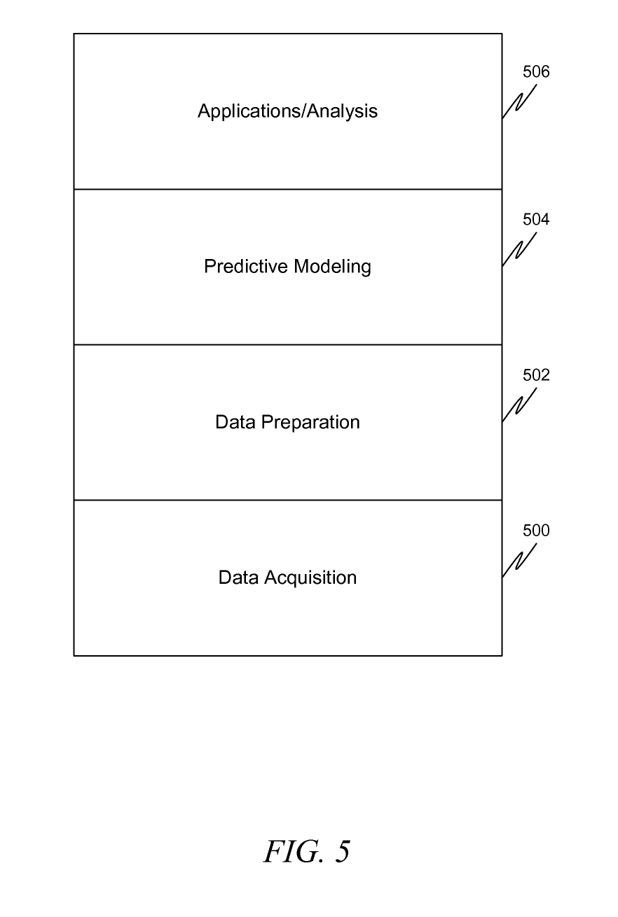

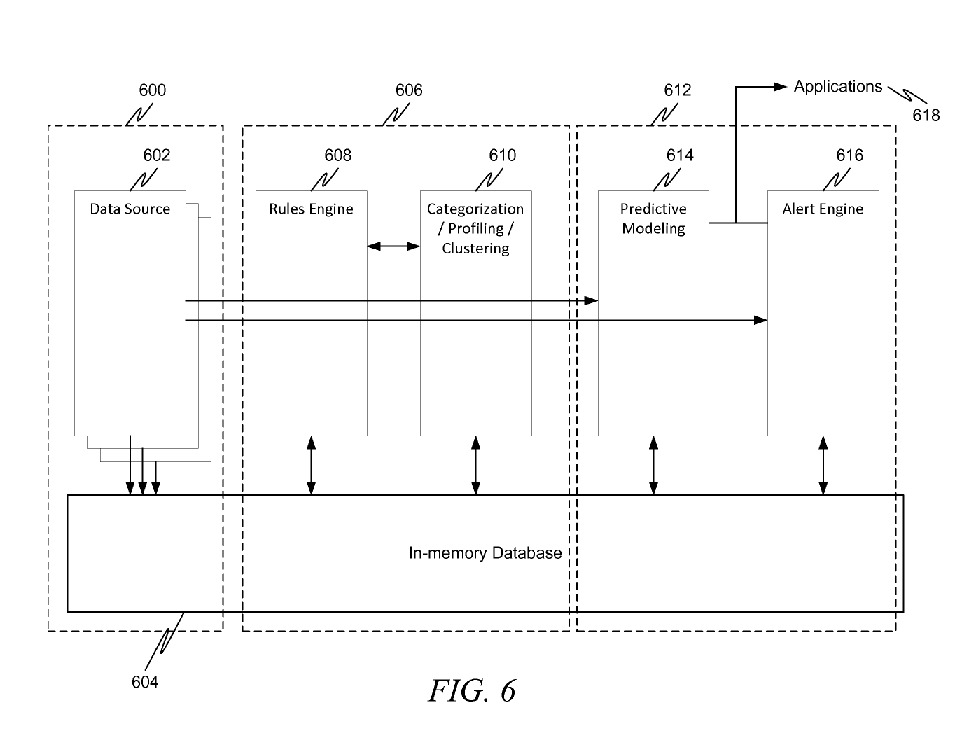

FIG. 5 is a diagram illustrating a representative process stack, in accordance with an example embodiment. FIG. 6 is a diagram illustrating a system to predict product demand, in accordance with an example embodiment. These two figures will be discussed together as FIG. 6 may be viewed as an example implementation of the representative process stack of FIG. 5.

In FIG. 5, the first representative process may be data acquisition as illustrated by block 500 of FIG. 5. Data can include both data from traditional sources, such as sales history, scan-data, direct POS data, syndicated data, loyalty data, customer demographic data, and consumer panel data, as well as data having a qualitative aspect, such as weather, social media data, etc. Data can be acquired from a variety of services and through a variety of mechanisms. The rise of web services on the internet makes data that was formerly difficult and/or expensive to obtain readily accessible, much of the time for free or low cost. However, the challenge today is not availability of the data, but in understanding and interpreting and transforming the data into actionable intelligence.

Weather data is available for geographic locations and regions and can be obtained in various time increments, such as every second, minute, hour, day, etc. As discussed above, weather data can contain a variety of meteorological parameters such as temperature, precipitation, humidity, etc, by geographic location and/or region. Both historical and forecasted data is available.

Data from social media sites typically has a qualitative component such as opinion data regarding products, frequency of product/company mention, positive or negative trending, etc. Such data can also be used in the system.

Data from traditional sources, such as sales history, scan-data, direct POS data, syndicated data, loyalty data, and consumer panel data, may include a wide variety of information, such as the particular product sold, the Universal Product Code/International Article Number (UPC/EAN), the product category, product group, account, account hierarchy, target group, consumer demographic information (e.g. gender, age, location, etc) and/or any other type of information, consistent with appropriate privacy policies and laws.

Turning to FIG. 6, data acquisition is illustrated by dashed box 600. FIG. 6 illustrates at least one data source 602 producing information that is stored by in-memory database 604. In-memory database 604 may be a database such as that illustrated in FIG. 3. Although FIG. 6 illustrates data from data source(s) 602 being placed directly into in-memory database 604, there may be intermediate devices/systems as well. For example, weather data may be collected from a web service and stored in a particular location. The collected data may then be post-processed in some manner, perhaps by a third party. Such post processing may, for example, normalize or rationalize data values, account for missing data points through interpolation or other strategies, convert data formats, or any number of like processing. The data may then be retrieved as needed from a location where the post-processed data is stored. Furthermore, not all data need be retrieved from the same location or handled in the same fashion.

Returning to FIG. 5, after the desired data is acquired, the data is prepared as illustrated by block 502. Data preparation may include quantifying data with a qualitative aspect, categorizing the data, combining data sets, clustering data around most frequent combinations of parameters or around designated parameters, or otherwise preparing the data to be used in the next block.

In FIG. 6, data preparation is illustrated by dashed box 606, which includes rules engine 608 and categorization/profiling/clustering engine 610. As previously explained, some of the acquired data may have a qualitative aspect. Such data is quantified by rules engine 608. Quantification is accomplished by rules engine 608 thorough a set of rules that allow rules engine to identify how the data should be quantified. The set of rules may accommodate perceptions, such as when weather is “hot” or “cold” or “good” or “bad”. Typically this is accomplished by identifying sets of parameters in the data and limits on the sets of parameters that fall within various quantification levels. As previously explained, quantification may occur on a scale like 0 or 1, 1-10 or 1-5 or any other type of scale where one direction represents an increasing degree of “badness” and the other direction represents an increasing degree of “goodness”. Quantification can occur independently for a parameter (e.g. temperature or perceived product value) or for multiple combined parameters (e.g. temperature, humidity and precipitation). In the case of multiple parameters that are quantified based on combinations of parameters, each parameter can be thought of as a dimension to the data with combinations of parameters (e.g. “regions” within the multi-dimensional space) having a particular degree of “goodness” or “badness”.

The quantification process can also include a confidence level parameter(s) that measures the confidence associated with the quantification level of a data point. Confidence levels can also be associated with the entire data set and not just a data point. Confidence levels can also be assigned to express the likelihood that a particular parameter will exist in the data set, such as a temperature at a particular time in a particular geographic region.

Categorization/profiling/clustering engine 610 can perform one or more of the indicated functions as appropriate for the data set(s). Categorization typically consists of categorizing the data according to one or more parameters attributes). If for example, the system is to enrich sales data with weather or other quantified data, the quantified data needs to be categorized so it can be combined with the sales data at the appropriate level. For example, suppose sales data is categorized by one or more parameters such as the particular product sold, the Universal Product Code/International Article Number (UPC/EAN), the product category, product group, account, account hierarchy, target group, consumer demographic information (e.g. gender, age, consumer residence location, etc.) and/or geographic sales location. Also suppose that quantified weather data has temperature, precipitation, humidity, historical confidence level of the particular temperature, precipitation and humidity, and geographic location. Also assume that the sales data and weather data overlap in time. An appropriate combination can be made between the sales data and quantified weather data by correlating the geographic locations and time. Also if a particular sales promotion effort was in place for at least some of the time, the actual effect of the promotion can be noted and determined from the data. Confidence level can also be taken into account during the combination process to produce confidence levels on the resulting enriched data.

In categorizing data, sometimes quantified data applies across multiple of the parameters. For example, if data from a social media site indicated increasing references to a particular brand, but no particular product was mentioned, then the quantified data from the social media site may be applied across all products. Alternatively, data from other sources may indicate a more narrow application. In the above example, if a particular promotion targeting a particular demographic of the social media site was focused on a particular subset of products of that brand, then the quantified data from the social media site may be applied to those targeted products. Confidence levels can be associated with inferences such as these when combining data or enriching data with quantified data.

As noted above clustering can take place along any of the parameters in the data set. Thus, clustering of the enriched data set can take place on any of the parameters (or any combination of parameters) in the enriched set. Clustering can be performed around selected parameters or categorization/profiling/clustering engine 610 can identify frequently occurring parameters or combinations of parameters to identity the more common parameters/combinations that occur. Finally clustering around a parameter or combination of parameters may be applied in a predictive manner to what would be expected around other parameters, for example.

Profiling is about using the information gained from the above steps for a certain profile of products, product groups, customers, customer groups, regions, etc or a combination of these that may use the same categorization of one or multiple demand influencing factors. Far example, if there is a new product introduced that has a similar profile to existing products (e.g. price level, consumer perception) this new product may be in the same profile applying the same or weighted demand influencing factors like the peers in the profile. There might be no actual historic data, however using the profile information predictions are possible.

As noted above profiling can take place along any of the parameters in the data set. Thus, profiling of the master data for use of the enriched data set can take place on any of the parameters (or any combination of parameters) in the enriched set. Profiling can be performed around selected parameters or categorization/profiling/clustering engine 610 can identify frequently occurring parameters or combinations of parameters to identify the more common parameters/combinations that occur. Finally profiling around a parameter or combination of parameters may be applied in a predictive manner to what would be expected around other parameters, for example.

As illustrated in 606, in-memory database 604, rules engine 608 and categorization engine 610 may all work together in data preparation. That is data may be stored and retrieved from in-memory database 604 during the operation of rules engine 608 and categorization/profiling/clustering engine 610. Similarly, functionality of the in-memory database 604, the rules engine 608, and categorization/profiling/clustering engine 610 may all work together to accomplish the desired functionality.

Returning to FIG. 5, after the data is prepared, predictive modeling may occur as indicated in block 504. Predictive modeling may rely on not only enriched data from block 504, but other data as well. Predictive modeling can occur in a variety of ways and various tools exist that can take data and create a predictive model.

In FIG. 6, the predictive modeling aspect is illustrated as dashed box 612. Predictive modeling occurs in predictive modeling engine 614. An example of a predictive modeling engine is the SAP Trade Promotion Optimization application from SAP AG of Walldorf, Germany. The SAP Trade Promotion Optimization application includes advanced modeling and predictive analytic capabilities to enable marketing and sales teams to systematically predict and optimize promotion outcomes, including revenue and profit, for both manufacturers and retailers. When the enriched data set produced by 606 is utilized, analysis and planning may be based not only on such factors as order history and other internal data, retail point-of-sale, syndicated retail measurement data and market research data, but also based on the qualitative data that had been quantified and used to enrich such data.

Other systems and/or methodologies may also be used, such as a predictive model created using a regression analysis on various parameter dimensions previously discussed above. Such a regression analysis can include a least squares multiple regression analysis on the enriched data set in order to quantify the relationship between various parameters in the enriched data set.

Alert engine 616 is illustrated as part of area 612. However, inclusion of such an alert, engine is optional. Weather and other qualitative information used in the enriched data set (after quantification) may be automatically considered in modeling and subsequent forecasting. Alert engine 616 may be based on short-term weather forecasts (for example) and may indicate a change should be made to trade promotions (e.g. modification or elimination), prices should be changed, etc. As an example, suppose predictive modeling based on historical data indicates that demand for certain beverages increases during the World Cup. However, suppose predictive modeling based on enriched data indicates that demand for these same beverages falls when precipitation is above a particular level. Thus, if plans had been made for a particular distribution and/or promotion during an upcoming World Cup, and the forecast indicated a large amount of precipitation, the alert engine 616 may use information from the predictive modeling engine 614 to decide that an alert should be given that the distribution and/or promotion plan should be reconsidered in light of projected weather.

Returning to FIG. 5, information from predictive modeling 504 may be used by various applications and/or in various analysis as indicated by 506. Since data used in the predictive modeling has been enhanced by information of a qualitative nature, the analysis and applications can be more rich and accomplish functions heretofore unavailable. In FIG. 6, the analysis and/or applications are indicated by 618.

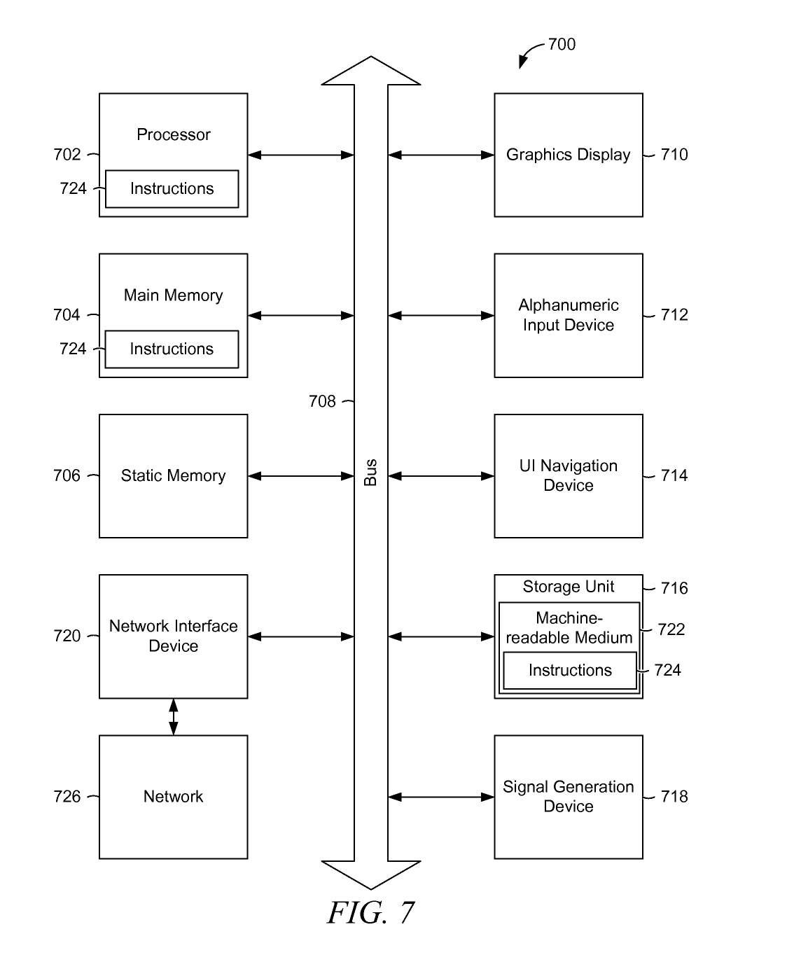

FIG. 7 is a block diagram of a computer processing system, within which, a set of instructions for causing the computer to perform any one or more of the methodologies discussed herein may be executed.

Embodiments may also, for example, be deployed by Software-as-a-Service (SaaS), Application Service Provider (ASP), or utility computing providers, in addition to being sold or licensed via traditional channels. The computer may be a server computer, a personal computer (PC), a tablet PC, a set-top box (STB), a personal digital assistant (PDA), cellular telephone, or any processing device capable of executing a set of instructions (sequential or otherwise) that specify actions to be taken by that device. Further, while only a single computer is illustrated, the term “computer” shall also be taken to include any collection of computers that individually or jointly execute a set (or multiple sets) of instructions to perform any one or more of the methodologies discussed herein.

The example computer processing system 700 includes processor 702 (e.g., a central processing unit (CPU), a graphics processing unit (GPU) or both), main memory 704 and static memory 706, which communicate with each other via bus 708. The processing system 700 may further include graphics display 710 (e.g., a plasma display, a liquid crystal display (LCD) or a cathode ray tube (CRT) or other display). The processing system 760 also includes alphanumeric input device 712 (e.g., a keyboard), a user interface (UI) navigation device 714 (e.g., a mouse, touch screen, or the like), a storage unit 716, a signal generation device 718 (e.g., a sneaker), and a network interface device 720.

The storage unit 716 includes machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the processing system 700, with the main memory 704 and the processor 702 also constituting computer-readable, tangible media.

The instructions 724 may further be transmitted or received over network 726 via a network interface device 720 utilizing any one of a number of well-known transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions 724. The term “machine-readable medium” shall also be taken to include any medium that is capable of storing, encoding or carrying a set of instructions for execution by the computer and that cause the computer to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, and optical and magnetic media.

While various implementations and exploitations are described, it will be understood that these embodiments are illustrative and that the scope of the claims is not limited to them. In general, techniques for maintaining consistency between data structures may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general structures and functionality presented as separate components in the exemplary configurations may be implemented as a combined structure or component. Similarly, structures and functionality presented as a single component may be implemented as separate components. These and other variations, modifications, additions, and improvements fall within the scope of the claims.

While the embodiments are described with reference to various implementations and exploitations, it will be understood that these embodiments am illustrative, and that the scope of claims provided below is not limited to the embodiments described herein. In general, the techniques described herein may be implemented with facilities consistent with any hardware system or hardware systems defined herein. Many variations, modifications, additions, and improvements are possible.

The term “computer readable medium” is used generally to refer to media embodied as non-transitory subject matter, such as main memory, secondary memory, removable storage, hard disks, flash memory, disk drive memory, CD-ROM and other forms of persistent memory. It should be noted that program storage devices, as may be used to describe storage devices containing executable computer code for operating various methods, shall not be construed to cover transitory subject matter, such as carrier waves or signals. “Program storage devices” and “computer-readable medium” are terms used generally to refer to media such as main memory, secondary memory, removable storage disks, hard disk drives, and other tangible storage devices or components.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method for predicting consumer demand for an entity Comprising:
obtaining first data relating to a qualitative parameter that impacts demand for an entity as the data varies over a range thereby giving the first data a qualitative aspect;
obtaining second data relating to demand for the entity;
quantifying the first data according to a set of rules to change the qualitative aspect of the first data into a quantitative data set;
categorizing the first data according to a dimension of the second data to obtain enriched data comprising second data relating to demand for the product and quantified first data; and
building a predictive model based on the enriched data, the predictive model receiving as an input a value and returning a metric predicting demand for the product.

2. The method of claim 1, further comprising clustering the enriched data around a dimension of the second data.

4. The method of claim 1, further comprising indicating when the metric falls below a desired threshold only, when the metric falls above a desired threshold only or when the metric falls either above or below a desired threshold.

5. The method of claim 1, wherein the entity is a product and wherein the second data comprises sales data for the product.

6. The method of claim 5, wherein the enhanced data is clustered by at least one of Universal Product Code/International Article Number (UPC/EAN), product category, product group, account, account hierarchy, or target group.

7. The method of claim 1, wherein the first data is weather data comprising temperature.

8. The method of claim 1, wherein the first data is derived from a social media source.

9. The method of claim 1, wherein the set of rules vary by geographic location so that first data from one geographic location is quantified differently than first data from a different geographic location.

10. A system comprising:
a computer processor and a computer storage device configured to:
access a first data set comprising data relating to a parameter that impacts demand for a product as the data varies over a range;
access a second data set comprising data relating to demand for the product;
quantify the first data set according to a set of rules that indicate a plurality of levels of desirability;
combine the quantified first data set with the second data set to produce an enriched data set.

11. The system of claim 10, wherein the first data set comprises weather data.

12. The system of claim 11, wherein the first data set further comprises geographic location.

13. The system of claim 12, wherein the set of rules vary by geographic location such that first data from one geographic location is quantified differently than first data from a different geographic location.

14. The system of claim 10, wherein the first data set comprises data from a social media network.

15. The system of claim 10, wherein the system further comprises memory and wherein the database manager comprises an index server configured to persist data in the memory.

16. The system of claim 10, wherein the enriched data set is clustered by at least one of Universal Product Code/International Article Number (UPC/BAN), product category, product group, account, account hierarchy, or target group.

17. A machine-readable storage medium comprising instructions that, when executed by at least one processor of a machine, comprise:
a database manager configured to:
store a first data set comprising data relating to a parameter that impacts demand for a product as the data varies over a range;
store a second data set comprising data relating to demand for the product;
a rules engine configured to quantify the first data set according to a set of rules that vary according to a geographic location of the first data set;
a categorizer configured to combine the quantified first data set with the second data set to produce an enriched data set.

18. The machine-readable storage medium of claim 17, wherein the instructions further comprise a predictive modeling engine configured to receive a value of the parameter and, in response, predict demand for the product based on the value of the parameter.

19. The machine-readable storage medium of claim 17, wherein the first data set comprises weather data including temperature for the geographic location.

20. The machine-readable storage medium of claim 17, wherein the enriched data set is categorized by at least one of Universal Product Code/International Article Number (UPC/EAN), product category, product group, account, account hierarchy, or target group.
